(19) United States
(12) Patent Application Publication
(10) Pub. No.: US 2011/0177229 A1
(43) Pub. Date: Jul. 21, 2011

(54) Food preservatives

(76) Inventors: Gil J. Bakal, New York, NY (US); Richard F. Stockel, Bridgewater, NJ (US); Brandon D. Baer, Hoboken, NJ (US); Bruce A. Nascimbeni, Hopewell, NJ (US)

(21) Appl. No.: 13/065,684

(22) Filed: Mar. 28, 2011

Related U.S. Application Data
(63) Continuation-in-part of application No. 12/156,539, filed on Jun. 2, 2008, now abandoned.
(60) Provisional application No. 60/929,571, filed on Jul. 3, 2007.

(51) Int. Cl. A23L 1/232

(52) U.S. Cl. 426/650

(57) ABSTRACT

A food preservative composition comprising a N^{α}-alkyl-dibasic amino acid alkyl ester salt in combination with liquid smoke. Preferably, the food preservative composition comprises a N^{α}-alkyl-dibasic amino acid alkyl ester halide salt in combination with liquid smoke. The particularly preferred composition comprises N^{α}-lauroyl-L-arginine ethyl ester hydrochloride in combination with clarified liquid smoke. The composition preferably also contains a surfactant and/or a solubilizer and/or a non-toxic GRAS solvent.

### CROSS-REFERENCE TO RELATED APPLICATIONS

This application is a continuation-in-part of utility patent application Ser. No. 12/156,539 filed Jun. 2, 2008 as a follow-on to provisional patent application Ser. No. 60/929,571 filed Jul. 3, 2007 (now abandoned). The disclosures of the foregoing utility patent application and the provisional patent application are incorporated by reference in their entirety.

### FIELD OF THE INVENTION

The invention relates to compositions which are employed to preserve a variety of foodstuffs.

### BACKGROUND OF THE INVENTION

Food preservative compositions containing a N^{α}-alkyl-dibasic amino acid alkyl ester salt such as N^{α}-lauroyl-L-arginine ethyl ester hydrochloride salt (hereinafter referred to as “LAE”) are known in the prior art. For example, see U.S. Pat. Nos. 3,825,560; 5,780,658; 7,074,447; and 7,087,769 as well as US patent publications 2004/0166082; 2004/017350; 2004/0254232; 2004/0265443; 20050175747; and 2006/0177540. Such prior art teach that LAE is useful for preserving foodstuffs.

Liquid smoke (hereinafter referred to as “LS”) is well known in the prior art as a flavoring agent for food stuffs. LS is reported to impart a slight bacteriocidal effect to foodstuffs since LS contains organic acids, e.g. acetic, which lower pH and destroy bacteria cell walls. Also, LS contains phenolic compounds, which are traditionally involved in flavor formation and such compounds are well-known bacteriocides.

A host of US patents pertain to processes for producing liquid smoke and their use for imparting flavor and color in foodstuffs. Such patents include, e.g. U.S. Pat. Nos. 4,154,866; 4,298,435; 4,959,232; 5,043,174; 5,637,339; 6,214,395; 6,261,623; and 6,541,053 as well as US patent publication 2005/0175746.

### Objects of the Invention

An object of the present invention is to provide a composition that is safe for use as a preservative for foodstuffs and that will have a high kill rate of bacteria that may be present in such food stuffs.

A further object of the present invention is provide a composition that is safe for use as a preservative for foodstuffs and that will inhibit the re-growth of bacteria in food stuffs after an acceptable kill rate of bacteria that may be present in such food stuffs has been achieved, i.e. lengthen the antimicrobial kill time, thus permitting long-term preservation of foodstuffs.

An additional object of the present invention is to provide a composition that is safe for use as a preservative for foodstuffs that is cost-effective.

Yet another object of the present invention is to provide a composition that is safe for use as a preservative for foodstuffs that is organoleptically satisfying.

The foregoing objects and other objects disclosed below have been achieved by means of the present invention.

### SUMMARY OF THE INVENTION

The invention pertains to a food preservative composition comprising a N^{α}-alkyl-dibasic amino acid alkyl ester salt in combination with liquid smoke. The composition may also include one or more surfactants and/or one or more solubilizers and/or one or more non-toxic GRAS (Generally Recognized As Safe) solvents.

### DETAILS OF THE INVENTION

The N^{α}-alkyl-dibasic amino acid alkyl ester salt will be present in an amount of about 10 to about 500 ppm, preferably about 25 to about 250 ppm, based on the weight of the food after treatment with the composition of the invention. The liquid smoke will be present in an amount of about 0.05 to about 5.0 wt. %, preferably about 0.10 to about 3.0 wt. %, based on the weight of the food after treatment with the composition of the invention.

Preferably, the amino acid moiety of the N^{α}-alkyl-dibasic amino acid alkyl ester salt is selected from the group consisting of arginine, lysine and histadine, with arginine being most preferred. Also, the anionic moiety of the N^{α}-alkyl-dibasic amino acid alkyl ester salt is preferably selected from the group consisting of a halide, sulfate, phosphate, carboxylate, hydroxy-carboxylate and phenolate, with halide being most preferred. The especially preferred salt is LAE.

Preferably, the liquid smoke is processed to reduce color and flavor, prior to its use in the present invention. One method of such processing is known as clarification in which the liquid smoke is treated with activated carbon and thereafter filtered to remove any extraneous solids.

It is useful to include one or more surfactants, solubilizers and/or non-toxic GRAS solvents in the food preservative compositions of the invention. The surfactants may be present in an amount of about 10.0 to about 200 wt. %, preferably 50-150 wt. %, based on the weight of the salt employed in treating the food. The solubilizers may be present in an amount of about 10.0 to about 700 wt. %, preferably 100 to 300 wt. %, based on the weight of the salt employed in treating the food. The solvents may be present in an amount of about 500 to about 10,000 wt. %, preferably 1,000 to 6,000 wt. %, based on the weight of the salt employed in treating the food.

For the purposes of the present invention, the surfactants may be cationic, anionic, nonionic or amphoteric in nature and combinations of the foregoing types of surfactants may also be employed. Examples of useful surfactants include an ethoxylated sorbitol; a di-block polyethylene oxide; a tri-block polyethylene; a mixture of a major amount of polyethylene oxide and a minor amount of propylene oxide; and combinations of the foregoing surfactants. Other useful surfactants include cationic surfactants such as D,L-2-pyrrolidone-5-carboxylic acid salt of ethyl-N-cocoyl-L-arginate, cocoamidopropyl PG dimonium chloride phosphate, and the like. Examples of useful nonionic surfactants include alcohols, alkanolamides, amine oxides, esters, ethoxylated and propoxylated carboxylic acids, ethoxylated and propoxylated glycerides, glycol esters and derivatives thereof, mono- and di-glycerides, polyglycerol esters, polyhydric alcohol esters and ethers, sorbitan and sorbitol esters, di- and tri-esters of phosphoric acid, esters, ethoxylated and propoxylated alcohols, ethoxylated and propoxylated lanolin, ethoxylated and propoxylated polysiloxanes, ethoxylated and propoxylated block copolymers, and the like. Suitable classes of amphoteric surfactants include N-alkylamino acids, alkyldimethyl betaines, alkylamino betaines, imidazolines, amino and imino propionates, and the like.

Examples of useful solubilizers include polyoxyethylene sorbitan monolaurate; glycerol monolaurate; polyglycerol esters, e.g. polyglycerol-3-stearate, polyglycerol-6-caprylate, polyglycerol-3-oleate, polyglycerol-3-palmitate polyglycerol-5-laurate; lecithin; monoglyceride citric acid esters; blends of lecithin, ethoxylated mono-/di-glycerides and propylene glycol; 1,4-anhydro-D-glucitol, 6-dodecanoate; L-proline; and the like.

Examples of useful non-toxic, GRAS solvents include ethanol, polyethylene glycols, propylene glycol, glycerine, sorbital, polysorbate, triacetin, C₁-C₁₀ glycerol monoesters and mixtures thereof.

A wide variety of foodstuffs which may be preserved using the compositions of the invention, e.g. meat, poultry, crustaceans, fish, beverages, juices, wines, beers, vegetables, salads, sauces, confectionary products, baked goods, pre-cooked meals, ready-to-serve meals, dairy products.

The following examples shall serve to illustrate the invention. Unless otherwise indicated all parts and amounts are on a weight basis. It is to be understood that these examples are provided for illustrative purposes only and do not represent any limitations as to the scope of the invention. The only limitations on the scope of the invention are those imposed by the claims which follow the examples.

### Example 1

The purpose of this example was to evaluate the efficiency of LAE/LS combination to inhibit the re-growth of L. monocytogenes over long-term shelf life in hot dog purge. Hot dogs were inoculated with a L. monocytogenes pool, stored at refrigeration and thereafter sampled for 150 days. The treatment samples consisted of water, 33 ppm LAE in water and 33 ppm LAE in LS. The inoculum consisted of 1 ml of 3 organism L. monocytogenes pool. Dilutions were made with modified letheen broth and plated with modified oxoid agar. The results are shown in the table set forth below. The conclusion that is derived from these results is that LAE in LS had better bactericidal activity than LAE alone. This conclusion was confirmed by repeating the experiment using a 5 strain L. monocytogenes pool recovered from outbreaks as the inoculum and treating the samples with LAE alone, LS alone and LAE/LS combination. The combination exhibited both inhibition and suppression of re-growth.

Log Recovered L. monocytogenes in Inoculated Hot Dogs

| | Day | | | | | | | | | | |
|---|---|---|---|---|---|---|---|---|---|---|---|
| | 0 | 1 | 7 | 30 | 60 | 75 | 90 | 105 | 120 | 130 | 140 |
| Control | 6.20 | 6.19 | 5.87 | 6.04 | 6.54 | 9.51 | 9.59 | 9.92 | 10.00 | 10.38 | 10.30 |
| LAE in water | 6.20 | 3.37 | 3.40 | 3.50 | 6.30 | 6.56 | 8.51 | 9.43 | 9.83 | 10.36 | 9.80 |
| LAE in LS | 6.20 | 3.32 | 3.85 | 3.35 | 4.14 | 3.79 | 3.81 | 5.84 | 6.57 | 6.26 | 6.90 |

### Example 2

The purpose of this example was to evaluate the efficacy of a LAE/LS combination to extend the shelf-life of raw pork products. Samples of several pork products were surface-treated with a combination of 33 ppm LAE in LS and monitored for shelf-life improvement versus untreated samples. Visual observations and microbiological testing data served as markers for end of shelf-life. The results are set forth below:

| | | |
|---|---|---|
| Ribs | 45% improvement in shelf-life | 9 days extra |
| Pumped Ribs | 85% improvement in shelf-life | 13 days extra |
| Tenderloins* | >10% improvement in shelf-life | >3 days extra |

*Tenderloin treated samples were still good on the last day of testing. The end shelf-life date was not determined.

The conclusion derived from this example is that the treated samples showed a significant improvement in shelf-life over the untreated samples.

### Example 3

Fresh sausage was treated with a combination of 33 ppm LAE in LS sufficient to cover the surface of the sausage and monitored for shelf-life versus untreated sausage. The monitoring consisted of visual inspections with a date being given when sausage was deemed unacceptable and the product was marked as failed. The results are set forth in the following table:

| Sample # | Control Failed Day | Sample # | Cytostat Failed Day |
|---|---|---|---|
| 1 | 26 | 1 | 34 |
| 2 | 34 | 2 | 40 |
| 3 | 22 | 3 | 34 |
| 4 | 22 | 4 | 34 |
| 5 | 38 | 5 | 38 |
| 6 | 26 | 6 | 40 |
| 7 | 38 | 7 | 34 |
| 8 | 22 | 8 | 40 |
| 9 | 40 | 9 | 34 |
| 10 | 40 | 10 | 34 |
| 11 | 22 | 11 | 40 |
| 12 | 28 | 12 | 36 |
| 13 | 22 | 13 | 36 |
| AVG. | 29.4 | AVG. | 36.5 |

The conclusion derived from this example is that the treated samples showed an average of a 7-day improvement in shelf-life over the untreated samples.

### Example 4

The purpose of this example was to evaluate the time to kill the indicated bacterium. Cultures were transferred from refrigerated stock plates into Tryptic Soy Broth and incubated for 24 to 48 hours at 30-35° C. Peptone water (0.2%) was used to prepare a 5-6 log(cfu/ml) inoculum for each test. The samples employed in this example were as follows:
Sample 1: Water Control. 9 ml sterile de-ionized water was dispensed into sterile test tubes.
Sample 2: 50 ppm LAE. Cytoguard LA™ was used as the source of the LAE. 4.5 g were added to 995.5 ml sterile de-ionized water and dispensed in 9 ml aliquot portions for testing.
Sample 3: 10 ppm LAE. Cytoguard LA™ was used as the source of the LAE. 0.9 g was added to 999.1 ml sterile de-ionized water and dispensed in 9 ml aliquot portions for testing.
Sample 4: Undiluted LS was employed in 9 ml aliquot portions for testing.
Sample 5: 50 ppm LAE in LS. Cytoguard LA™ was used as the source of the LAE source. 4.5 g were added to 995.5 ml LS and dispensed in 9 ml aliquot portions for testing.
Sample 6: 10 ppm LAE in LS. Cytoguard LA™ was used as the source of the LAE. 0.9 g was added to 999.1 ml LS and dispensed in 9 ml portions for testing.

All samples were made fresh at room temperature for each test date. Recovery was made after one minute and after 10 minutes as indicated below.

The testing procedure was carried out as follows: Each sample was inoculated with the indicated inoculum and vortexed well for 10 seconds. At the selected time interval, a 1 ml aliquot was removed and transferred into 9 ml of sterile Letheen Broth. From the resultant Broth, sequential dilutions were prepared and plated with standard methods agar (pour plates with 22-23 ml of molten agar at 45° C.)

After the agar plates had solidified, they were incubated at 30-35° C. for 48-72 hours. The plates were removed from incubation and counted using a Quebec colony counter. The cfu's that were recovered were recorded and converted to log recovered or percent recovered. These values were subtracted from the controls (Sample 1) to provide log reduction or percent reduction values.

L. monocytogenes Results After 1 Minute

| | Log | | Log | Percent |
|---|---|---|---|---|
| Sample | Recovered | +/− | Reduction | Reduction |
| 1 | 6.42 | 0.10 | NA | NA |
| 4 | 6.33 | 0.03 | 0.09 | 20.3704 |
| 3 | 3.79 | 0.07 | 2.63 | 99.7685 |
| 2 | 1.95 | 0.17 | 4.47 | 99.9965 |
| 6 | 1.60 | 0.00 | 4.82 | 99.9985 |
| 5 | 1.00 | 0.00 | 5.42 | 99.9996 |

| | | |
|---|---|---|
| Sample | 1 Minute | 10 Minutes |

Log Recovered C. albicans

| | | |
|---|---|---|
| 1 | 6.00 | 5.89 |
| 4 | 5.96 | 3.82 |
| 2 | 5.57 | 4.15 |
| 5 | 5.72 | 2.48 |

Log Recovered S. aureus

| | | |
|---|---|---|
| 1 | 6.13 | 6.18 |
| 4 | 6.16 | 5.81 |
| 2 | 6.00 | 5.91 |
| 5 | 5.83 | 3.43 |

Log Recovered S. cholerasuis

| | | |
|---|---|---|
| 1 | 4.88 | 4.75 |
| 4 | 4.49 | 2.04 |
| 2 | 1.70 | 1.30 |
| 5 | 4.30 | 0.70 |

### Example 5

The purpose of this example was to evaluate the re-growth of spoilage organisms in fresh ground turkey after treatment with LAE, LS and LAE/LS combination. The samples employed in this example were as follows:
Sample 1: Water Control. 10 ml sterile de-ionized water was dispensed into 500 g of ground turkey.
Sample 2: LS. 10 ml of LS was sprayed into 500 g of ground turkey, mixed well and placed in a sealed, sterile plastic bag.
Sample 3: 200 ppm LAE. 10 ml of an LAE solution was sprayed into 500 g of ground turkey, mixed well and placed in a sealed, sterile plastic bag.
Sample 4: 200 ppm LAE in LS. 10 ml of a LAE/LS solution was sprayed into 500 g of ground turkey, mixed well and placed in a sealed, sterile plastic bag.

All of the bags were sealed and stored at refrigeration temperature for the length of this study. The recovery method was as follows:

From each bag, 20 g of product was aseptically removed and placed in sterile stomacher bags. 180 ml of sterile Peptone water (0.2%) was added to the sample, stomached for one minute, mixed well and 1:10 dilutions were made (one ml aliquot was removed and transferred into 9 ml of sterile Letheen Broth). From these sequential dilutions, 1 ml was pipetted and plated. The spoilage organisms were recovered using Plate Count Agar. The agar plates were solidified and incubated at 30-35° C. for 48 hours. The plates were removed from incubation and counted using a Quebec colony counter. The cfu's recovered were recorded and converted to log recovered. These values were subtracted from the controls to provide log reduction. The log reduction values are set forth in the table below.

Spoilage Organisms Re-Growth

| | Days | | | | |
|---|---|---|---|---|---|
| Sample | 2 | 5 | 7 | 10 | 11 |
| 1 | 5.11 | 6.41 | 7.31 | 7.34 | 7.41 |
| 2 | 4.63 | 4.75 | 4.41 | 4.76 | 5.25 |
| 3 | 4.60 | 6.05 | 7.22 | 7.25 | 8.25 |
| 4 | 4.10 | 4.18 | 3.96 | 3.72 | 3.29 |

What is claimed is:

1. A food preservative composition comprising a N^{α}-alkyl-dibasic amino acid alkyl ester salt in combination with liquid smoke.

2. The composition of claim 1 wherein the amino acid moiety of the salt is selected from the group consisting of arginine, lysine and histadine.

3. The composition of claim 2 wherein the N^{α}-alkyl-dibasic amino acid alkyl ester comprises N^{α}-lauroyl-L-arginine ethyl ester.

4. The composition of claim 1 wherein the anionic moiety of the salt is selected from the group consisting of a halide, sulfate, phosphate, carboxylate, hydroxy-carboxylate and phenolate.

5. The composition of claim 4 wherein the anionic moiety comprises a halide.

6. The composition of claim 1 wherein the salt comprises N^{α}-lauroyl-L-arginine ethyl ester hydrochloride.

7. The composition of claim 1 wherein the salt is present in an amount of about 10 to about 500 ppm, based on the weight of the food after treatment with the salt.

8. The composition of claim 1 wherein the liquid smoke is present in an amount of about 0.05 to about 5.0 wt. %, based on the weight of the weight of the food after treatment with the liquid smoke.

9. The composition of claim 1 wherein the liquid smoke has been processed to reduce its color and flavor components.

10. The composition of claim 1 further comprising at least one surfactant selected from the group consisting of nonionic, cationic, anionic, amphoteric surfactants and mixtures of the foregoing types of surfactants.

11. The composition of claim 10 wherein the surfactant is selected from the group consisting of an ethoxylated sorbitol; a di-block polyethylene oxide; a tri-block polyethylene; a mixture of a major amount of polyethylene oxide and a minor amount of propylene oxide; and mixtures of the foregoing surfactants.

12. The composition of claim 10 wherein the surfactant is present in an amount of about 10.0 to about 200 wt. %, based on the weight of the salt employed in treating the food.

13. The composition of claim 1 further comprising at least one solubilizer.

14. The composition of claim 13 wherein the solubilizer is selected from the group consisting of polyoxyethylene sorbitan monolaurate; glycerol monolaurate; polyglycerol esters, e.g. polyglycerol-3-stearate, polyglycerol-6-caprylate, polyglycerol-3-oleate, polyglycerol-3-palmitate polyglycerol-5-laurate; lecithin; monoglyceride citric acid esters; blends of lecithin, ethoxylated mono-/di-glycerides and propylene glycol; 1,4-anhydro-D-glucitol, 6-dodecanoate; L-proline; and mixtures of the foregoing solubilizers.

15. The composition of claim 13 wherein the solubilizer is present in an amount of about 10.0 to about 200 wt. %, based on the weight of the salt employed in treating the food.

16. The composition of claim 1 further comprising a non-toxic GRAS solvent.

17. The composition of claim 16 wherein the solvent is selected from the group consisting of ethanol, polyethylene glycols, propylene glycol, glycerine, sorbital, polysorbate, triacetin, C₁-C₁₀ glycerol monoesters and mixtures of the foregoing solvents.

18. The composition of claim 16 wherein the solvent is present in an amount of about 500 to about 10,000 wt. %, based on the weight of the salt employed in treating the food.
